(19) United States
(12) Patent Application Publication
(10) Pub. No.: US 2026/0262081 A1
(43) Pub. Date: Sep. 3, 2026

(54) METHOD AND DEVICE FOR TRANSMITTING CHANNEL OCCUPANCY INFORMATION

(71) Applicant: Beijing Xiaomi Mobile Software Co., Ltd., Beijing (CN)

(72) Inventor: Wensu ZHAO, Beijing (CN)

(21) Appl. No.: 18/878,461

(22) PCT Filed: Jun. 29, 2022
(86) PCT No.: PCT/CN2022/102549

§ 371 Date: Dec. 23, 2024

(51) Int. Cl. H04W 74/0808; H04W 72/25

(52) U.S. Cl. CPC H04W 74/0808; H04W 72/25

(57) ABSTRACT

A channel occupancy information transmitting method, includes: a first terminal device receiving length-related information of channel occupancy information transmitted by a second terminal device; determining, according to the length-related information, a length of channel occupancy information that needs to be transmitted by the first terminal device before physical sidelink feedback channel (PSFCH) information is transmitted; and transmitting the channel occupancy information of the length before the PSFCH information is transmitted; where the first terminal device shares channel occupancy time (COT) initiated by the second terminal device, and the first terminal device and the second terminal device are in a unicast communication with each other.

### CROSS-REFERENCE TO RELATED APPLICATIONS

The present application present application is a U.S. National Stage of International Application No. PCT/CN2022/102549, filed on Jun. 29, 2022, the contents of all of which are incorporated herein by reference in their entireties for all purposes.

### BACKGROUND OF THE INVENTION

With the continuous emergence of new communication services and application demands, terminal sidelink (SL, also referred to as direct link) communication imposes increasingly high performance requirements in terms of transmission bandwidth, communication rate, communication delay, reliability, extendibility, etc. Currently, in the terminal sidelink communication over an unlicensed spectrum (sidelink-unlicensed (SL-U)), channel occupancy information can be used to occupy a channel in advance in order to guarantee continuity of data transmission and prevent an obtained channel from being occupied by a wireless fidelity (WIFI) device.

### SUMMARY OF THE INVENTION

Examples of the present disclosure provide a method for transmitting channel occupancy information, and a device, which relate to the technical field of communication.

In a first aspect, the examples of the present disclosure provide a method for transmitting channel occupancy information. The method is performed by a first terminal device. The method includes: receiving length-related information of the channel occupancy information transmitted by a second terminal device; determining, according to the length-related information, a length of the channel occupancy information that needs to be transmitted by the first terminal device before physical sidelink feedback channel (PSFCH) information is transmitted; and transmitting the channel occupancy information of the length before the PSFCH information is transmitted; where the first terminal device shares a channel occupancy time (COT) initiated by the second terminal device, and the first terminal device and the second terminal device are in unicast communication with each other.

In a second aspect, the examples of the present disclosure provide another method for transmitting channel occupancy information. The method is performed by a second terminal device. The method includes: transmitting length-related information of the channel occupancy information to a first terminal device, where the length-related information is configured to determine a length of the channel occupancy information that needs to be transmitted by the first terminal device before physical sidelink feedback channel (PSFCH) information is transmitted; where the first terminal device shares a channel occupancy time (COT) initiated by the second terminal device, and the first terminal device and the second terminal device are in unicast communication with each other.

In a third aspect, the examples of the present disclosure provide a communication device. The communication device includes one or more processors and a memory. The memory stores a computer program. The one or more processors are collectively configured execute the computer program stored in the memory to cause the communication device to:
receive length-related information of the channel occupancy information transmitted by a second terminal device;
determine, according to the length-related information, a length of the channel occupancy information that needs to be transmitted by the first terminal device before physical sidelink feedback channel (PSFCH) information is transmitted; and
transmit the channel occupancy information of the length before the PSFCH information is transmitted;
wherein the first terminal device shares a channel occupancy time (COT) initiated by the second terminal device, and the first terminal device and the second terminal device are in unicast communication with each other.

In a fourth aspect, the examples of the present disclosure provide a communication device. The communication device includes one or more processors and a memory. The memory stores a computer program. The one or more processors are collectively configured to execute the computer program stored in the memory to cause the communication device to perform the method of the second aspect.

In a fifth aspect, the examples of the present disclosure provide a communication device. The device includes one or more processors and an interface circuit. The interface circuit is configured to receive code instructions and transmit the code instructions to the one or more processors. The one or more processors are collectively configured to run the code instructions to cause the device to perform the method of the first aspect.

In a sixth aspect, the examples of the present disclosure provide a communication device. The device includes one or more processors and an interface circuit. The interface circuit is configured to receive code instructions and transmit the code instructions to the one or more processors. The one or more processors are collectively configured to run the code instructions to cause the device to perform the method of the second aspect.

In a seventh aspect, the examples of the present disclosure provide a non-transitory computer-readable storage medium, storing one or more programs, where the one or more programs are configured to be executed by one or more processors of a first terminal device, and the one or more programs include instructions for the first terminal device described above. The instructions, when executed by the first terminal device, cause the first terminal device to perform the method of the first aspect.

In an eighth aspect, the examples of the present disclosure provide a non-transitory computer-readable storage medium, storing one or more programs, where the one or more programs are configured to be executed by one or more processors of a second terminal device, and the one or more programs include instructions for the second terminal device described above. The instructions, when executed by the second terminal device, cause the second terminal device to perform the method of the second aspect.

### BRIEF DESCRIPTION OF DRAWINGS

In order to more clearly illustrate the examples of the present disclosure or the technical solution in the related art, the accompanying drawings required for the examples of the present disclosure or the related art will be explained below.

FIG. 1 is a schematic diagram of an architecture of a communication system according to an example of the present disclosure;

FIG. 2 is a schematic flowchart of a method for transmitting channel occupancy information according to an example of the present disclosure;

FIG. 3 is a schematic diagram of PSFCH information transmission when y is greater than z;

FIG. 4 is a schematic diagram of PSFCH information transmission when y is equal to z;

FIG. 5 is a schematic flowchart of a method for transmitting channel occupancy information according to another example of the present disclosure;

FIG. 6 is a schematic flowchart of a method for transmitting channel occupancy information according to another example of the present disclosure;

FIG. 7 is a schematic structural diagram of a first terminal device according to an example of the present disclosure;

FIG. 8 is a schematic structural diagram of a second terminal device according to an example of the present disclosure;

FIG. 9 is a schematic structural diagram of a communication device according to an example of the present disclosure; and

FIG. 10 is a schematic structural diagram of a chip according to an example of the present disclosure.

### DETAILED DESCRIPTION OF THE INVENTION

Examples of the present disclosure are described in detail below and illustratively shown in the accompanying drawings. The same or similar reference numerals denote the same or similar elements or elements having the same or similar functions throughout. The examples described below by reference to the drawings are illustrative for explaining the present disclosure and are not to be construed as limiting the present disclosure. In the description of the present disclosure, unless otherwise stated, “/” means or, for example, A/B may mean A or B; and “and/or” is used to describe an associated relationship between associated objects and means three relations here, for example, A and/or B may mean A alone, A and B together, and B alone.

In order to better understand a method for transmitting channel occupancy information disclosed in the examples of the present disclosure, a communication system to which the example of the present disclosure is applicable is first described below.

With reference to FIG. 1, FIG. 1 is a schematic diagram of an architecture of a communication system according to an example of the present disclosure. The communication system may include, but is not limited to, three terminal devices. The terminal devices communicate with each other through sidelink. A number and configurations of devices shown in FIG. 1 are for instance only and do not constitute a limitation on the example of the present disclosure. For example, the communication system shown in FIG. 1 includes a first terminal device 101, a second terminal device 102, and a third terminal device 103.

The first terminal device 101, the second terminal device 102 and the third terminal device 103 in the example of the present disclosure are entities configured to receive or transmit signals, such as a mobile phone. The terminal device may also be referred to as a terminal, user equipment (UE), a mobile station (MS), a mobile device (MT), etc. The terminal device may be a car with a communication function, a smart car, a mobile phone, a wearable device, a Pad, a computer with a radio transceiving function, a virtual reality (VR) terminal device, an augmented reality (AR) terminal device, a radio terminal device in industrial control, a radio terminal device in self-driving, a radio terminal device in remote medical surgery, a radio terminal device in a smart grid, a radio terminal device in transportation safety, a radio terminal device in a smart city, or a radio terminal device in smart home, etc. The example of the present disclosure does not limit a particular technology and a particular device configuration used by the terminal device.

It can be understood that the communication system described in the examples of the present disclosure is for the purpose of more clearly illustrating the technical solutions provided in the examples of the present disclosure, and does not constitute a limitation on the technical solutions provided in the examples of the present disclosure. Those skilled in the art will know that the technical solutions provided in the examples of the present disclosure are also applicable to similar technical problems along with evolution of a system architecture and emergence of new service scenes.

At present, in a 5G new radio in unlicensed spectrum (NR-U), a channel occupancy time (COT) is shared between a network device and a terminal device. When the network device shares the COT with the terminal device for use, the network device executes type 2 listen before talk (LBT). After the LBT succeeds, in a case that a symbol of uplink data transmission has not arrived yet, in order to guarantee that the COT is not interrupted, the network device indicates a length of a cyclic prefix extension (CPE) to the terminal device. The terminal device uses the CPE to occupy a channel in a first symbol of uplink transmission, and starts uplink transmission on the shared COT after the symbol of the uplink transmission has arrived.

With the continuous emergence of new communication services and application demands, terminal sidelink (SL, also referred to as direct link) communication imposes increasingly high performance requirements in terms of transmission bandwidth, communication rate, communication delay, reliability, extendibility, etc. Diverse application scenarios and requirements in the future cannot be satisfied by the limited licensed spectrum alone. Currently, in the terminal sidelink communication over an unlicensed spectrum (sidelink-unlicensed (SL-U)), channel occupancy information can be used to occupy a channel in advance in order to guarantee continuity of data transmission and prevent an obtained channel from being occupied by a wireless fidelity (WIFI) device. However, there is a lack of design related to channel occupancy information, for example, a specific implementation of the use of a cyclic prefix extension (CPE).

A method for transmitting channel occupancy information and a device provided in the present disclosure are described in detail below in conjunction with the accompanying drawings.

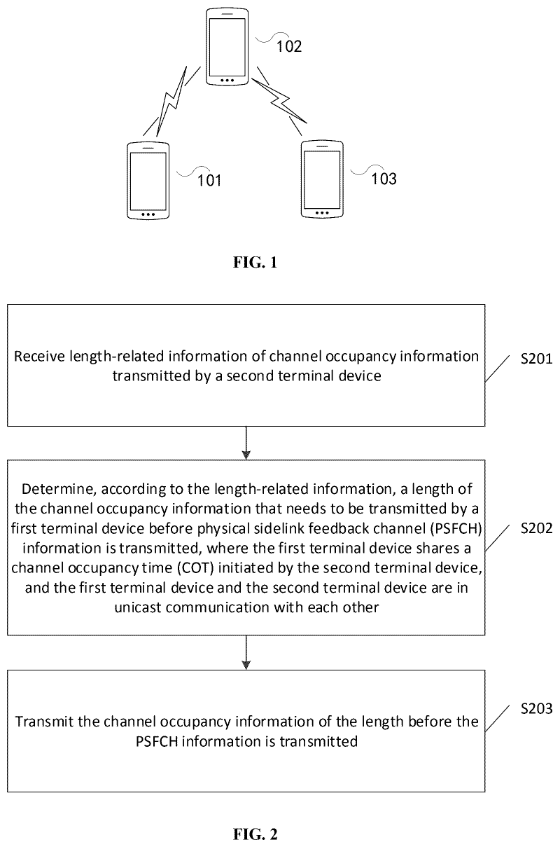

With reference to FIG. 2, FIG. 2 is a schematic flowchart of a method for transmitting channel occupancy information according to an example of the present disclosure. It should be noted that the method for transmitting channel occupancy information in the example of the present disclosure may be performed by a first terminal device. As shown in FIG. 2, the method for transmitting channel occupancy information may include, but is not limited to the following steps:
S201, length-related information of the channel occupancy information transmitted by a second terminal device is received.

In some examples of the present disclosure, the length-related information is carried by any one of the following: sidelink control information (SCI), media access control control element (MAC CE) information or radio resource control (RRC) information. The SCI is, for example, first-stage SCI or second-stage SCI. In an instance, the RRC information may be RRC information for a plurality of terminal devices. The plurality of terminal devices include the first terminal device. In another instance, the RRC information may be RRC information for the first terminal device. The RRC information carries an identifier of the first terminal device, etc.

In an instance, the first terminal device may receive SCI transmitted by the second terminal device. The SCI carries the length-related information. In another instance, the first terminal device may receive the MAC CE information transmitted by the second terminal device. The MAC CE information carries the length-related information. In another instance, the first terminal device may receive the RRC information transmitted by the second terminal device. The RRC information carries the length-related information

In some other examples, the first terminal device may perform S201 as follows: the length-related information is received from the second terminal device. The length-related information and first information are jointly encoded. The first information includes either of the following: a channel access type or a channel access priority class (CAPC).

In an instance, the first terminal device may receive joint coding information transmitted by the second terminal device. The joint coding information is obtained by joint coding of the length-related information and the channel access type. In another instance, the first terminal device may receive joint coding information transmitted by the second terminal device. The joint coding information is obtained by joint coding of the length-related information and the CAPC.
S202, according to the length-related information, a length of the channel occupancy information that needs to be transmitted by a first terminal device before physical sidelink feedback channel (PSFCH) information is transmitted is determined, where the first terminal device shares a channel occupancy time (COT) initiated by the second terminal device, and the first terminal device and the second terminal device are in unicast communication with each other.

In the example of the present disclosure, the first terminal device and the second terminal device are in unicast communication with each other. The first terminal device may be a reception end. The second terminal device may be a transmission end. In an instance, the first terminal device, serving as the reception end, may only transmit the PSFCH information to the second terminal device.

In another instance, the first terminal device, serving as the reception end, may transmit the PSFCH information and other information to the second terminal device. The other information includes, for example, physical sidelink control channel (PSCCH) information, and physical sidelink shared channel (PSSCH) information. The PSFCH information may be, for example, hybrid automatic repeat request-acknowledge (HARQ-ACK) feedback information.

In the example of the present disclosure, the length-related information may be, for example, an index number. The index number corresponds to an LBT time and/or a timing advance (TA) TTA. The LBT time and/or the timing advance (TA) are/is configured to determine the length of the channel occupancy information. A corresponding relation between the index number and the LBT time and/or the timing advance (TA) may be as shown in Table 1 below.

TABLE 1
Corresponding relation between index number and
LBT time and/or timing advance (TA)

| | Channel | |
|---|---|---|
| Index | access type | C value |
| 0 | type 2A | 25 · 10⁻⁶ + T_{TA} |
| 1 | type 2B | 16 · 10⁻⁶ + T_{TA} |
| 2 | type 2C | T_{TA} |

In Table 1, index indicates the index number. The C value represents the LBT time and/or the timing advance (TA). Under the condition that the index number corresponds to the LBT time and the timing advance (TA), the C value may be a sum of the LBT time and the timing advance (TA). Under the condition that the index number corresponds to only the timing advance (TA), the value C may be the timing advance (TA).

In Table 1, a value of the index number may be any of the following values: 0, 1, or 2. When the index number is 0, corresponding LBT time and corresponding timing advance (TA) are provided. The corresponding LBT time is 25·10⁻⁶ seconds, and the corresponding timing advance (TA) is TTA seconds. When the index number is 1, corresponding LBT time and corresponding timing advance (TA) are provided. The corresponding LBT time is 16·10⁻⁶ seconds, and the corresponding timing advance (TA) is TTA seconds. When the index number is 2, corresponding timing advance (TA) is provided. The corresponding timing advance (TA) is TTA seconds.

In some examples, the corresponding relation between the index number and the LBT time and/or timing advance (TA) in Table 1 may be preconfigured in the first terminal device.

In the example of the present disclosure, under the condition that the length-related information is an index number and the index number corresponds to an LBT time and/or a timing advance (TA), the first terminal device may perform S202 as follows: the LBT time and/or the timing advance (TA) corresponding to the index number are/is obtained by querying a preconfigured index table according to the index number; and the length of the channel occupancy information is determined according to the LBT time and/or the timing advance (TA), a start position of the PSFCH information, and an end position of PSCCH information or PSSCH information of the second terminal device before the PSFCH information.

In some examples, the second terminal device first transmits data during the channel occupancy time initiated by the second terminal device. A start time slot of the channel occupancy time serves as slot x, assuming that the second terminal device transmits information in a sidelink transmission manner from slot x to slot z, the first terminal device receives the information transmitted by the second terminal device from slot x to slot z; and the first terminal device returns the PSFCH information, that is, a response to the transmitted information, for example, HARQ information, to the second terminal device on slot y. First 11 symbols of slot y are configured to transmit the PSCCH information or the PSSCH information. A transmission position of the PSFCH information on slot y is located at a start position of a 12th symbol. The 11th symbol needs to be reserved for the LBT time and/or the timing advance (TA).

It should be noted that the sidelink transmission manner refers to sidelink transmission that is time-continuous, that is, information transmission exists on a plurality of consecutive time slots. With slot x to slot z as an example, in an instance, the second terminal device performs time-continuous sidelink transmission to the first terminal device on slot x to slot z. In another instance, information transmission exists on each slot from slot x to slot z, for example, sidelink transmission from the second terminal device to the first terminal device, or sidelink transmission from the first terminal device to the second terminal device. The time-continuous may mean that a time interval between adjacent sidelink transmission is less than a predetermined threshold.

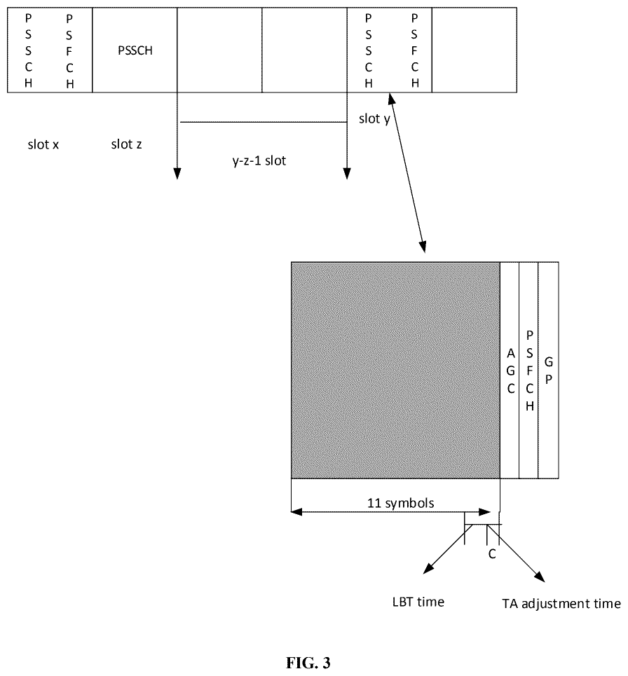

In one of the above instances, y is greater z. FIG. 3 is a schematic diagram of PSFCH information transmission when y is greater than z. In FIG. 3, the channel occupancy information needs to be transmitted in a time interval from the end position of slot z to the start position of the LBT in the 11th symbol. The length of the channel occupancy information is a length of the time interval. Under the condition that y is greater than z in FIG. 3, a calculation formula of the length of the channel occupancy information may be as shown in the following formula (1).

$$L = ( y - z - 1 ) \times 14 \times symbol length + 11 symbol lengths - C \qquad ( 1 )$$

L represents the length of the channel occupancy information; C represents the sum of the LBT time and/or the timing advance (TA) corresponding to the index number; and one time slot includes 14 symbol lengths.

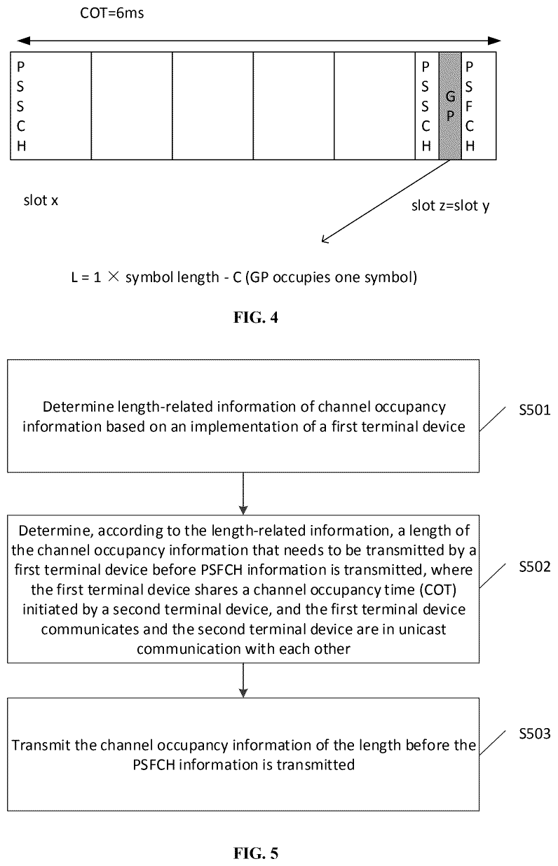

In another instance of the above instances, y is equal to z. FIG. 4 is a schematic diagram of PSFCH information transmission when y is equal to z. In FIG. 4, slot z coincides with slot y where the PSFCH information is located, that is, each slot in the channel occupancy time is used by the first terminal device or the second terminal device. The first terminal device transmits PSFCH information and other information in slot y. The other information includes, for example, physical sidelink control channel (PSCCH) information, and physical sidelink shared channel (PSSCH) information. The PSFCH information may be, for example, hybrid automatic repeat request-acknowledge (HARQ-ACK) feedback information.

In FIG. 4, a time interval between an end position of the PSSCH information and a start position of the PSFCH information in slot z, that is GP in FIG. 4, needs to transmit the channel occupancy information. The length of the channel occupancy information is a length of the time interval. Under the condition that y is equal to z in FIG. 4, a calculation formula of the length of the channel occupancy information may be as shown in the following formula (2).

$$L = 1 \times symbol length - C \qquad ( 2 )$$

L represents the length of the channel occupancy information. A length of the GP is one symbol, and the LBT time and/or the timing advance (TA) corresponding to the index number need to be reserved in the symbol. The sum of the LBT time and/or the timing advance (TA) is the C value, and L is a difference between the length of one symbol and the C value.

For a position of slot z, in an instance, the second terminal device may indicate an offset value of slot z relative to slot x to the first terminal device on slot x. In the instance, position of slot z=position of slot x+offset. In another instance, the second terminal device may instruct the first terminal device on slot x to transmit a number n of slots occupied by the information in a sidelink transmission manner. In the instance, position of slot z=position of slot x+(n−1). In the above two instance, the first terminal device may determine the position of slot x by decoding information transmitted by the second terminal device.

In another instance, the second terminal device may indicate an offset value of slot z relative to slot k to the first terminal device on any slot k between slot x and slot z. In the instance, the first terminal device may determine the position of slot k by decoding information transmitted by the second terminal device.

For the position of slot y, in an instance, the first terminal device preconfigures a slot in which the PSFCH information is located. In another instance, the first terminal device may determine the position of slot y according to PSFCH related parameters (for example, a period of the PSFCH) and the position of slot x. In another instance, the first terminal device may determine the position of slot y according to PSFCH related parameters (for example, a period of the PSFCH) and the position of slot z. The period of one PSFCH may be, for example, four slots.

In an instance of the example of the present disclosure, the first terminal device and the second terminal device may both support continuous multi-slot transmission, and in this case, values of z and x may be the same or not. The same means that the second terminal device uses only one slot to transmit information, and the different means that the second terminal device may use a plurality of slots to transmit information. In another instance, neither the first terminal device nor the second terminal device support continuous multi-slot transmission, and in this case, values of z and x may be the same.

It should be noted that under the condition that the first terminal device and the second terminal device both support continuous multi-slot transmission, the HARQ information returned by the first terminal device on slot y is response information for the PSCCH information or PSSCH information repeatedly transmitted by the second terminal device for the last time on slot x to slot z. Under the condition that neither the first terminal device nor the second terminal device support continuous multi-slot transmission, the HARQ information returned by the first terminal device on slot y is response information for the PSCCH information or PSSCH information first transmitted by the second terminal device on slot x to slot z.

In the example of the present disclosure, the channel occupancy information is a cyclic prefix extension defined in NR-U, or information for channel occupancy other than the cyclic prefix extension. In an instance, the channel occupancy information may be a cyclic prefix extension defined in NR-U. A length of the cyclic prefix extension defined in NR-U is less than or equal to the length of one symbol. The cyclic prefix extension is located before the transmitted information. In another instance, the channel occupancy information may be information for occupying a channel other than the cyclic prefix extension. A length of the information for occupying a channel other than the cyclic prefix extension may be less than or equal to the length of one symbol, and may also be greater than the length of one symbol. The information may be located before or after the transmitted information.
S203, the channel occupancy information of the length is transmitted before the PSFCH information is transmitted.

According to the method for transmitting channel occupancy information in the example of the present disclosure, the first terminal device receives the length-related information of the channel occupancy information transmitted by the second terminal device; determines, according to the length-related information, a length of the channel occupancy information that needs to be transmitted by the first terminal device before PSFCH information is transmitted, where the first terminal device shares a channel occupancy time (COT) initiated by the second terminal device, and the first terminal device and the second terminal device are in unicast communication with each other; and transmits the channel occupancy information of the length before the PSFCH information is transmitted. Thus no idle time interval within a channel occupancy time can be guaranteed, and continuity of information transmission within the channel occupancy time can be guaranteed.

It should be noted that the above possible implementations may be performed separately or may be performed in combination, which are not limited in the example of the present disclosure.

With reference to FIG. 5, FIG. 5 is a schematic flowchart of a method for transmitting channel occupancy information according to another example of the present disclosure. It should be noted that the method for transmitting channel occupancy information in the example of the present disclosure may be performed by a first terminal device.

The method for transmitting channel occupancy information may be performed separately, may be performed in combination with any example of the present disclosure or a possible implementation in the example, or may be performed in combination with any technical solution in the related art.

As shown in FIG. 5, the method for transmitting channel occupancy information may include, but is not limited to the following steps:
S501, length-related information of the channel occupancy information is determined based on an implementation of the first terminal device.

In the example of the present disclosure, the length-related information may be, for example, an index number. The index number corresponds to an LBT time and/or a timing advance (TA). The LBT time and/or the timing advance (TA) are/is configured to determine the length of the channel occupancy information.

A value of the index number may be any of the following values: 0, 1, and 2. When the index number is 0, corresponding LBT time and corresponding timing advance (TA) are provided. The corresponding LBT time is 25·10⁻⁶ seconds, and the corresponding timing advance (TA) is TTA seconds. When the index number is 1, corresponding LBT time and corresponding timing advance (TA) are provided. The corresponding LBT time is 16·10⁻⁶ seconds, and the corresponding timing advance (TA) is TTA seconds. When the index number is 2, corresponding timing advance (TA) is provided. The corresponding timing advance (TA) is TTA seconds.

In the example of the present disclosure, the first terminal device may select a value from the plurality values of the index number according to the implementation of the first terminal device, for example, actual requirements of the first terminal device, then determine the LBT time and/or the timing advance (TA), and further determine the length-related information.
S502, a length of the channel occupancy information that needs to be transmitted by a first terminal device before PSFCH information is transmitted is determined according to the length-related information, where the first terminal device shares a channel occupancy time (COT) initiated by the second terminal device, and the first terminal device and the second terminal device are in unicast communication with each other.

In the example of the present disclosure, the length-related information may be, for example, an index number. The index number corresponds to an LBT time and/or a timing advance (TA). The LBT time and/or the timing advance (TA) are/is configured to determine the length of the channel occupancy information.

In the example of the present disclosure, under the condition that the length-related information is an index number and the index number corresponds to an LBT time and/or a timing advance (TA), the first terminal device may perform S502 as follows: the LBT time and/or the timing advance (TA) corresponding to the index number are/is obtained by querying a preconfigured index table according to the index number; and the length of the channel occupancy information is determined according to the LBT time and/or the timing advance (TA), a start position of the PSFCH information, and an end position of PSCCH information or PSSCH information of the second terminal device before the PSFCH information.

In some examples, the second terminal device first transmits data during the channel occupancy time initiated by the second terminal device. A start time slot of the channel occupancy time serves as slot x, assuming that the second terminal device transmits information in a sidelink transmission manner from slot x to slot z, the first terminal device receives the information transmitted by the second terminal device from slot x to slot z; and the first terminal device returns the PSFCH information, that is, a response to the transmitted information, for example, HARQ information, to the second terminal device on slot y. First 11 symbols of slot y are configured to transmit the PSCCH information or the PSSCH information. A transmission position of the PSFCH information on slot y is located at a start position of a 12th symbol. The 11th symbol needs to be reserved for the LBT time and/or the timing advance (TA).

In one of the above instances, y is greater z. FIG. 3 is a schematic diagram of PSFCH information transmission when y is greater than z. In FIG. 3, the channel occupancy information needs to be transmitted in a time interval from the end position of slot z to the start position of the LBT in the 11th symbol. The length of the channel occupancy information is a length of the time interval.

In another instance of the above instances, y is equal to z. FIG. 4 is a schematic diagram of PSFCH information transmission when y is equal to z. In FIG. 4, slot z coincides with slot y where the PSFCH information is located, that is, each slot in the channel occupancy time is used by the first terminal device or the second terminal device. The first terminal device transmits PSFCH information and other information in slot y. In FIG. 4, a time interval between an end position of the PSSCH information and a start position of the PSFCH information in slot z, that is GP in FIG. 4, needs to transmit the channel occupancy information. The length of the channel occupancy information is a length of the time interval.

In an instance of the example of the present disclosure, the first terminal device and the second terminal device may both support continuous multi-slot transmission, and in this case, values of z and x may be the same or not. The same means that the second terminal device uses only one slot to transmit information, and the different means that the second terminal device may use a plurality of slots to transmit information. In another instance, neither the first terminal device nor the second terminal device support continuous multi-slot transmission, and in this case, values of z and x may be the same.

In the example of the present disclosure, the channel occupancy information is a cyclic prefix extension defined in NR-U, or information for channel occupancy other than the cyclic prefix extension. In an instance, the channel occupancy information may be a cyclic prefix extension defined in NR-U. A length of the cyclic prefix extension defined in NR-U is less than or equal to the length of one symbol. The cyclic prefix extension is located before the transmitted information. In another instance, the channel occupancy information may be information for occupying a channel other than the cyclic prefix extension. A length of the information for occupying a channel other than the cyclic prefix extension may be less than or equal to the length of one symbol, and may also be greater than the length of one symbol. The information may be located before or after the transmitted information.
S503, the channel occupancy information of the length is transmitted before the PSFCH information is transmitted.

According to the method for transmitting channel occupancy information in the example of the present disclosure, the first terminal device determines the length-related information of the channel occupancy information by an implementation of the first terminal device; determines, according to the length-related information, a length of the channel occupancy information that needs to be transmitted by the first terminal device before PSFCH information is transmitted, where the first terminal device shares a channel occupancy time (COT) initiated by the second terminal device, and the first terminal device and the second terminal device are in unicast communication with each other; and transmits the channel occupancy information of the length before the PSFCH information is transmitted. Thus no idle time interval within a channel occupancy time can be guaranteed, and continuity of information transmission within the channel occupancy time can be guaranteed.

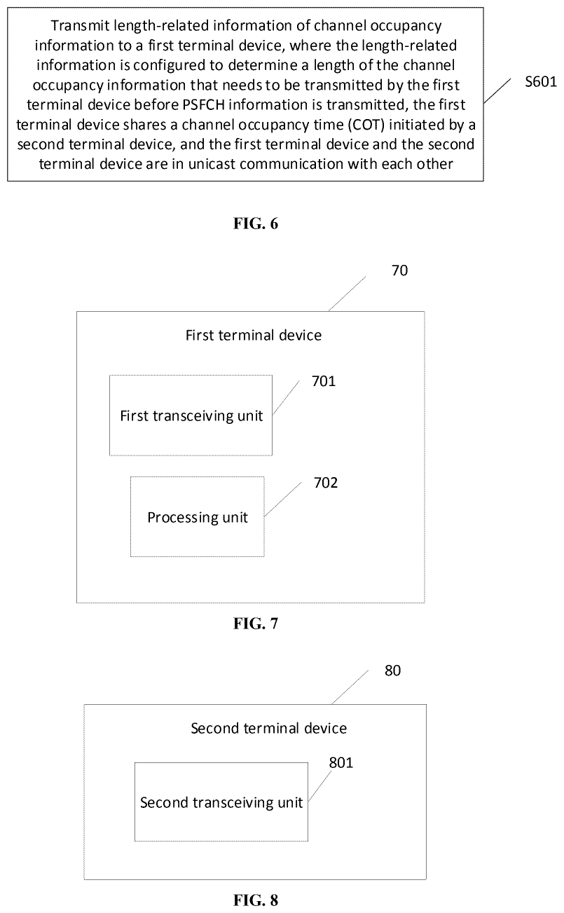

With reference to FIG. 6, FIG. 6 is a schematic flowchart of a method for transmitting channel occupancy information according to another example of the present disclosure. It should be noted that the method for transmitting channel occupancy information in the example of the present disclosure may be performed by a second terminal device. As shown in FIG. 6, the method for transmitting channel occupancy information may include, but is not limited to the following steps:
S601, length-related information of the channel occupancy information is transmitted to a first terminal device, where the length-related information is configured to determine a length of the channel occupancy information that needs to be transmitted by the first terminal device before PSFCH information is transmitted, the first terminal device shares a channel occupancy time (COT) initiated by the second terminal device, and the first terminal device and the second terminal device are in unicast communication with each other.

In the example of the present disclosure, the first terminal device and the second terminal device are in unicast communication with each other. The first terminal device may be a reception end. The second terminal device may be a transmission end. In an instance, the first terminal device, serving as the reception end, may only transmit the PSFCH information to the second terminal device.

In another instance, the first terminal device, serving as the reception end, may transmit the PSFCH information and other information to the second terminal device. The other information includes, for example, physical sidelink control channel (PSCCH) information, and physical sidelink shared channel (PSSCH) information. The PSFCH information may be, for example, hybrid automatic repeat request-acknowledge (HARQ-ACK) feedback information.

In the example of the present disclosure, the length-related information may be, for example, an index number. The index number corresponds to an LBT time and/or a timing advance (TA). The LBT time and/or the timing advance (TA) are/is configured to determine the length of the channel occupancy information.

A value of the index number may be any of the following values: 0, 1, and 2. When the index number is 0, corresponding LBT time and corresponding timing advance (TA) are provided. The corresponding LBT time is 25·10⁻⁶ seconds, and the corresponding timing advance (TA) is TTA seconds. When the index number is 1, corresponding LBT time and corresponding timing advance (TA) are provided. The corresponding LBT time is 16·10⁻⁶ seconds, and the corresponding timing advance (TA) is TTA seconds. When the index number is 2, corresponding timing advance (TA) is provided. The corresponding timing advance (TA) is TTA seconds.

In some of the examples of the present disclosure, the length-related information may be carried by any one of the following: SCI, MAC CE information or RRC information. The SCI is, for example, first-stage SCI or second-stage SCI. In an instance, the RRC information may be RRC information for a plurality of terminal devices. The plurality of terminal devices include the first terminal device. In another instance, the RRC information may be RRC information for the first terminal device. The RRC information carries an identifier of the first terminal device, etc.

In some other examples, the second terminal device may perform S601 as follows: the length-related information is transmitted to the first terminal device. The length-related information and first information are jointly encoded. The first information includes either of the following: a channel access type or a channel access priority class.

In an instance, the first terminal device may receive joint coding information transmitted by the second terminal device. The joint coding information is obtained by joint coding of the length-related information and the channel access type. In another instance, the first terminal device may receive joint coding information transmitted by the second terminal device. The joint coding information is obtained by joint coding of the length-related information and the CAPC.

In the example of the present disclosure, the channel occupancy information is a cyclic prefix extension defined in NR-U, or information for channel occupancy other than the cyclic prefix extension. In an instance, the channel occupancy information may be a cyclic prefix extension defined in NR-U. A length of the cyclic prefix extension defined in NR-U is less than or equal to the length of one symbol. The cyclic prefix extension is located before the transmitted information. In another instance, the channel occupancy information may be information for occupying a channel other than the cyclic prefix extension. A length of the information for occupying a channel other than the cyclic prefix extension may be less than or equal to the length of one symbol, and may also be greater than the length of one symbol. The information may be located before or after the transmitted information.

According to the method for transmitting channel occupancy information in the example of the present disclosure, the second terminal device transmits the length-related information of the channel occupancy information to the first terminal device. The length-related information is configured to determine the length of the channel occupancy information that needs to be transmitted by the first terminal device before the PSFCH information is transmitted. The first terminal device shares the channel occupancy time (COT) initiated by the second terminal device. The first terminal device and the second terminal device are in unicast communication with each other. Thus no idle time interval within a channel occupancy time can be guaranteed, and continuity of information transmission within the channel occupancy time can be guaranteed.

In the above examples provided in the present disclosure, the method provided by the examples of the present disclosure is introduced from the perspectives of the first terminal device and the second terminal device separately. In order to implement functions in the method provided in the above examples of the present disclosure, the first terminal device and the second terminal device may include a hardware structure and a software module. The above functions are implemented in a form of a hardware structure, a software module, or a hardware structure and a software module. Any one of the above functions may be performed by a hardware structure, a software module, or a hardware structure and a software module.

With reference to FIG. 7, FIG. 7 is a schematic structural diagram of a first terminal device 70 according to an example of the present disclosure. The first terminal device 70 includes: a first transceiving unit 701 configured to receive length-related information of channel occupancy information transmitted by a second terminal device; and a second processing unit 702 configured to determine, according to the length-related information, a length of the channel occupancy information that needs to be transmitted by the first terminal device before PSFCH information is transmitted. The first transceiving unit 701 is further configured to transmit the channel occupancy information of the length before the PSFCH information is transmitted. The first terminal device shares a channel occupancy time (COT) initiated by the second terminal device, and the first terminal device and the second terminal device are in unicast communication with each other.

In an embodiment, the length-related information is carried by any one of the following: sidelink control information (SCI), media access control control element (MAC CE) information or radio resource control (RRC) information.

In an embodiment, the first transceiving unit 701 is specifically configured to receive the length-related information from the second terminal device. The length-related information and first information are jointly encoded. The first information includes either of the following: a channel access type or a channel access priority class.

In an embodiment, the length-related information is an index number, and the index number corresponds to a listen before talk (LBT) time and/or a timing advance (TA); and the LBT time and/or the timing advance (TA) are/is configured to determine the length of the channel occupancy information.

In an embodiment, the processing unit 702 is specifically configured to: obtain the LBT time and/or the timing advance (TA) corresponding to the index number by querying a preconfigured index table according to the index number; and determine the length of the channel occupancy information according to the LBT time and/or the timing advance (TA), a start position of the PSFCH information, and an end position of PSCCH information or PSSCH information of the second terminal device before the PSFCH information.

In an embodiment, the channel occupancy information is a cyclic prefix extension defined in NR-U, or information for channel occupancy other than the cyclic prefix extension.

With reference to FIG. 8, FIG. 8 is a schematic structural diagram of a second terminal device 80 according to an example of the present disclosure. The second terminal device 80 includes: a second transceiving unit 801 configured to transmit length-related information of the channel occupancy information to a first terminal device. The length-related information is configured to determine a length of the channel occupancy information that needs to be transmitted by the first terminal device before PSFCH information is transmitted. The first terminal device shares a channel occupancy time (COT) initiated by the second terminal device. The first terminal device and the second terminal device are in unicast communication with each other.

In an embodiment, the length-related information is carried by any one of the following: sidelink control information (SCI), media access control control element (MAC CE) information or radio resource control (RRC) information.

In an embodiment, the second transceiving unit 801 is specifically configured to transmit the length-related information to the first terminal device. The length-related information and first information are jointly encoded. The first information includes either of the following: a channel access type or a channel access priority class.

In an embodiment, the length-related information is an index number, and the index number corresponds to a listen before talk (LBT) time and/or a timing advance (TA); and the LBT time and/or the timing advance (TA) are/is configured to determine the length of the channel occupancy information.

In an embodiment, the channel occupancy information is a cyclic prefix extension defined in NR-U, or information for channel occupancy other than the cyclic prefix extension.

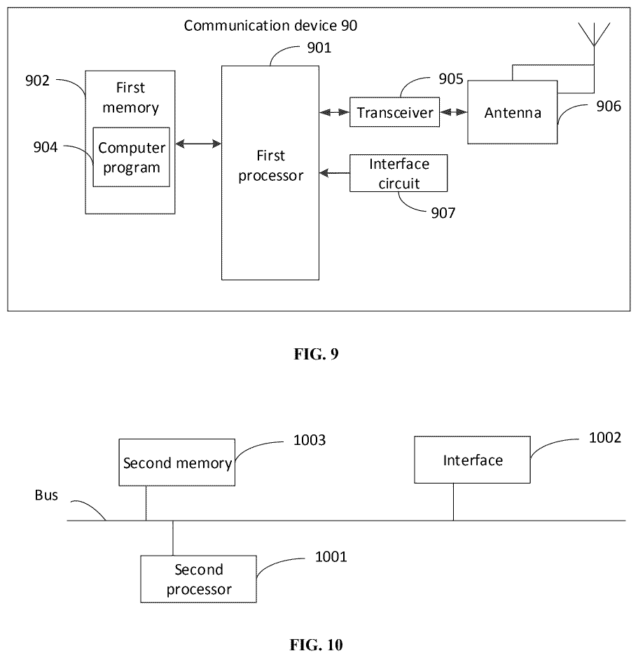

With reference to FIG. 9, FIG. 9 is a schematic structural diagram of a communication device 90 according to an example of the present disclosure. The communication device 90 may be a terminal device (such as the first terminal device or the second terminal device in the foregoing method examples), and may also be a chip, a chip system, or a processor that supports the terminal device to implement the above method. The device may be configured to implement the methods described in the above method examples, and reference may be made to description in the above method examples for details.

The communication device 90 may include one or more first processors 901. The first processor 901 may be a general purpose processor or a special purpose processor, etc., such as a baseband processor or a central processor. The baseband processor may be configured to process a communication protocol and communication data. The central processor may be configured to control a communication device (for example, a base station, a baseband chip, a terminal device, a terminal device chip, a DU or a CU), execute a computer program, and process data of the computer program.

Optionally, the communication device 90 may further include one or more first memories 902 that may store a computer program 904. The first processor 901 executes the computer program 904 to cause the communication device 90 to perform the method described in the above method examples. Optionally, the first memory 902 may also store data. The communication device 90 and the first memory 902 may be arranged separately or may be integrated together.

Optionally, the communication device 90 may further include a transceiver 905 and an antenna 906. The transceiver 905 may be referred to as a transceiving unit, a transceiving machine, a transceiving circuit, etc., and is configured to implement a transceiving function. The transceiver 905 may include a receiver and a transmitter. The receiver may be referred to as a receiving machine or a receiving circuit, etc., for implementing a reception function. The transmitter may be referred to as a transmitting machine, a transmitting circuit, etc., for implementing a transmission function.

Optionally, the communication device 90 may further include one or more interface circuits 907. The interface circuit 907 is configured to receive a code instruction and transmit the code instruction to the first processor 901. The first processor 901 runs the code instruction to cause the communication device 90 to perform the method described in the above method examples.

When the communication device 90 is a first terminal device, the first processor 901 is configured to perform S202 in FIG. 2, and S501 and S502 in FIG. 5. The transceiver 905 is configured to perform S201 and S203 in FIG. 2, and S503 in FIG. 5.

When the communication device 90 is a second terminal device, the transceiver 905 is configured to perform step 601 in FIG. 6.

In an implementation, the first processor 901 may include a transceiver for implementing a reception function and a transmission function. For example, the transceiver may be a transceiving circuit, an interface, or an interface circuit. The transceiving circuit, interface, or interface circuit for implementing the reception function and the transmission function may be separated or integrated. The transceiving circuit, interface or interface circuit may be configured to read and write a code/data, or the transceiving circuit, interface or interface circuit may be configured to transmit or transfer a signal.

In one implementation, the first processor 901 may store a computer program 904. The computer program 904 runs on the first processor 901 and causes the communication device 90 to perform the method described in the method examples above. The computer program 904 may be embedded in the first processor 901. In this case, the first processor 901 may be implemented by hardware.

In an implementation, the communication device 90 may include a circuit that may implement the functions of transmission, reception or communication in the foregoing method examples. The first processor 901 and transceiver 905 described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The first processor 901 and transceiver 905 may also be fabricated by using various IC process technologies, such as a complementary metal oxide semiconductor (CMOS), an n-metal-oxide-semiconductor (NMOS), a positive channel metal oxide semiconductor (PMOS), a bipolar junction transistor (BJT), a bipolar CMOS (BiCMOS), silicon germanium (SiGe), and gallium arsenide (GaAs).

The communication device 90 described in the above example may be a network device or a terminal device (such as the first terminal device in the foregoing method examples), but the scope of the communication device described in the present disclosure is not limited to this, and a structure of the communication device may not be limited by FIG. 9. The communication device may be a stand-alone device or may be part of a large device. For example, the communication device may be:
(1) an independent integrated circuit (IC), a chip, a chip system or a subsystem;
(2) a set of one or more ICs, optionally including a memory component for storing data and a computer program;
(3) an ASIC, such as a modem;
(4) a module that can be embedded in other devices;
(5) a receiver machine, a terminal device, an intelligent terminal device, a cellular phone, a radio device, a handset, a mobile unit, a vehicle-mounted device, a network device, a cloud device, an artificial intelligence device, etc.; and
(6) a different device.

Reference may be made to a schematic structural diagram of a chip shown in FIG. 10 for the case that the communication device may be a chip or a chip system. The chip shown in FIG. 10 includes a second processor 1001 and an interface 1002. One or more second processors 1001 may be provided. A plurality of interfaces 1102 may be provided.

Optionally, the chip further includes a second memory 1003. The second memory 1003 is configured to store a necessary computer program and data.

Those skilled in the art will further appreciate that the various illustrative logical blocks and steps set forth in the examples of the present disclosure may be implemented by electronic hardware, computer software, or combinations of both. Whether such functions are implemented by hardware or software depends on a particular application and overall system design requirements. Those skilled in the art may use various methods to implement the functions for each particular application, but such an implementation should not be understood as beyond the scope of protection of the examples of the present disclosure.

The examples of the present disclosure further provide a communication system. The system includes the first terminal device in the example of FIG. 7 and the second terminal device in the example of FIG. 8.

The present disclosure further provides a readable storage medium. The readable storage medium stores an instruction. The instruction when executed by a computer, cause the computer to implement the functions of any one of the method examples.

The present disclosure further provides a computer program product. The computer program product when executed by a computer, cause the computer to implement the functions of the method examples.

The examples described above can be implemented in whole or in part by software, hardware, firmware, or their any combinations. When implemented through the software, all or some of the modules may be implemented in the form of computer program products. The computer program product includes one or more computer programs. When loaded and executed on a computer, the computer program generates in whole or in part the flows or functions described in accordance with the examples of the present disclosure. The computer may be a general-purpose computer, a special-purpose computer, a computer network, or another programmable device. The computer program may be stored in a computer-readable storage medium or transmitted by one computer-readable storage medium to another computer-readable storage medium. For example, the computer program can be transmitted by one website, computer, server, or data center to another website, computer, server, or data center through a wired means (for example, a coaxial cable, an optical fiber, and a digital subscriber line (DSL)) or through a radio means (for example, infrared, radio waves, and microwaves). The computer-readable storage medium may be any available medium that can be accessed by a computer or a data storage device including one or more available media integrated server, a data center, etc. The available medium may be a magnetic medium (for example, a floppy disk, a hard disk, and a magnetic tape), an optical medium (for example, a digital video disk (DVD)), or a semiconductor medium (for example, a solid state disk (SSD)), etc.

Those skilled in the art may understand that the first, second and other numerical numbers referred to in the present disclosure are merely for distinction for convenience of description, instead of limiting the scope of the examples of the present disclosure, and represent the order of sequence.

At least one in the present disclosure may also be described as one or more, and the plurality may be two, three, four, or more, which are not limited in the present disclosure. In the examples of the present disclosure, for a type of technical features, technical features in this type of the technical features are distinguished by “first”, “second”, “third”, “A”, “B”, “C” and “D”, and the technical features described by the “first”, “second”, “third”, “A”, “B”, “C” and “D” are not in order of sequence or order of magnitude.

Corresponding relations shown in tables of the present disclosure may be configured or predefined. Values of information in each table are only instances, and may be configured differently, which is not limited in the present disclosure. When a correspondence relation between the information and each parameter is configured, it is not necessarily required to configure all the correspondence relations indicated in each table. For example, in the tables of the present disclosure, the corresponding relations shown in some rows may not be configured. For another example, appropriate modification adjustments, such as splitting and merging, can be made based on the above table. Names of the parameters shown in the titles of the above tables may also be other names that can be understood by the communication device, and values or expression modes of the parameters may also be other values or expression modes that can be understood by the communication device. When the tables are implemented, other data structures may also be used, such as an array, a queue, a container, a stack, a linear table, a pointer, a linked list, a tree, a graph, a structure, a class, a heap and a hash table.

Predefinition in the present disclosure may be understood as definition, predefinition, storage, pre-storage, pre-negotiation, pre-configuration, curing, or pre-firing.

Those of ordinary skill in the art may appreciate that the units and algorithm steps of the instances described in conjunction with the examples disclosed here may be implemented in electronic hardware, or a combination of computer software and electronic hardware. Whether these functions are performed with hardware or software depends on the specific application and design constraints of the technical solution. Those skilled in the art can use different methods to implement the described functions for each particular application, but such an implementation should not be deemed as falling beyond the scope of the present disclosure.

Those skilled in the art will clearly appreciate that, for convenience and conciseness of description, reference can be made to corresponding processes in the foregoing method examples for specific working processes of the above systems, devices and units, which are not repeated here.

What are described above are merely particular embodiments of the present disclosure, and are not intended to limit the scope of protection of the present disclosure, and any changes or substitutions that can readily occur to those skilled in the art within the scope of technology disclosed in the present disclosure should fall within the scope of protection of the present disclosure. Thus, the scope of protection of the present disclosure shall be subject to the scope of protection of the claims.

1. A method for transmitting channel occupancy information, performed by a first terminal device, the method comprising:
receiving length-related information of the channel occupancy information transmitted by a second terminal device;
determining, according to the length-related information, a length of the channel occupancy information that needs to be transmitted by the first terminal device before physical sidelink feedback channel (PSFCH) information is transmitted; and
transmitting the channel occupancy information of the length before the PSFCH information is transmitted;
wherein the first terminal device shares a channel occupancy time (COT) initiated by the second terminal device, and the first terminal device and the second terminal device are in unicast communication with each other.

2. The method according to claim 1, wherein the length-related information is carried by any one of the following: sidelink control information (SCI), media access control control element (MAC CE) information or radio resource control (RRC) information.

3. The method according to claim 1, wherein receiving the length-related information of the channel occupancy information transmitted by the second terminal device comprises:
receiving the length-related information from the second terminal device, wherein the length-related information and first information are jointly encoded;
wherein the first information comprises either of: a channel access type or a channel access priority class.

4. The method according to claim 1, wherein the length-related information is an index number, and the index number corresponds to at least one of a listen before talk (LBT) time or a timing advance (TA); and
wherein at least one of the LBT time or the timing advance (TA) is configured to determine the length of the channel occupancy information.

5. The method according to claim 4, wherein determining, according to the length-related information, the length of the channel occupancy information that needs to be transmitted by the first terminal device before PSFCH information is transmitted comprises:
obtaining at least one of the LBT time or the timing advance (TA) corresponding to the index number by querying a preconfigured index table according to the index number; and
determining the length of the channel occupancy information according to at least one of the LBT time or the timing advance (TA), a start position of the PSFCH information, and an end position of physical sidelink control channel (PSCCH) information or physical sidelink shared channel (PSSCH) information of the second terminal device before the PSFCH information.

6. The method according to claim 1, wherein the channel occupancy information is a cyclic prefix extension defined in a new radio in unlicensed spectrum (NR-U).

7. A method for transmitting channel occupancy information, performed by a second terminal device, the method comprising:
transmitting length-related information of the channel occupancy information to a first terminal device, wherein the length-related information is configured to determine a length of the channel occupancy information that needs to be transmitted by the first terminal device before physical sidelink feedback channel (PSFCH) information is transmitted;
wherein the first terminal device shares a channel occupancy time (COT) initiated by the second terminal device, and the first terminal device and the second terminal device are in unicast communication with each other.

8. The method according to claim 7, wherein the length-related information is carried by any one of the following: sidelink control information (SCI), media access control control element (MAC CE) information or radio resource control (RRC) information.

9. The method according to claim 7, wherein transmitting the length-related information of the channel occupancy information to the first terminal device comprises:
transmitting the length-related information to the first terminal device, wherein the length-related information and first information are jointly encoded;
wherein the first information comprises either of: a channel access type or a channel access priority class.

10. The method according to claim 7, wherein the length-related information is an index number, and the index number corresponds to at least one of a listen before talk (LBT) time or a timing advance (TA); and
wherein at least one of the LBT time or the timing advance (TA) is configured to determine the length of the channel occupancy information.

11. The method according to claim 7, wherein the channel occupancy information is a cyclic prefix extension defined in a new radio in unlicensed spectrum (NR-U).

12-13. (canceled)

14. A communication device, comprising one or more processors and a memory, wherein the memory stores a computer program, and the one or more processors are collectively configured to execute the computer program stored in the memory, to cause the communication device to:
receive length-related information of channel occupancy information transmitted by a second terminal device;
determine, according to the length-related information, a length of the channel occupancy information that needs to be transmitted by a first terminal device before physical sidelink feedback channel (PSFCH) information is transmitted; and
transmit the channel occupancy information of the length before the PSFCH information is transmitted;
wherein the first terminal device shares a channel occupancy time (COT) initiated by the second terminal device, and the first terminal device and the second terminal device are in unicast communication with each other.

15. A communication device, comprising one or more processors and a memory, wherein the memory stores a computer program, and the one or more processors are collectively configured to execute the computer program stored in the memory, to cause the communication device to perform the method according to claim 7.

16. A communication device, comprising one or more processors and an interface circuit, wherein
the interface circuit is configured to receive code instructions and transmit the code instructions to the one or more processors; and
the one or more processors are collectively configured to run the code instructions, to perform the method according to claim 1.

17. A communication device, comprising one or more processors and an interface circuit, wherein
the interface circuit is configured to receive code instructions and transmit the code instructions to the one or more processors; and
the one or more processors are collectively configured to run the code instructions, to perform the method according to claim 7.

18. A non-transitory computer-readable storage medium storing one or more programs, where the one or more programs are configured to be executed by one or more processors of the first terminal device, and the one or more programs comprise instructions, when executed by the first terminal device, cause the first terminal device to perform the method according to claim 1.

19. A non-transitory computer-readable storage medium storing one or more programs, where the one or more programs are configured to be executed by one or more processors of the second terminal device, and the one or more programs comprise instructions, when executed by the second terminal device, cause the second terminal device to perform the method according to claim 7.

20. The method according to claim 1, wherein the channel occupancy information is information for channel occupancy other than a cyclic prefix extension.

21. The method according to claim 7, wherein the channel occupancy information is information for channel occupancy other than a cyclic prefix extension.
